(19) United States
(12) Patent Application Publication
(10) Pub. No.: US 2016/0148226 A1
(43) Pub. Date: May 26, 2016

(54) SYSTEM AND METHOD FOR FORECASTING AND MANAGING RETURNED MERCHANIDSE IN RETAIL

(71) Applicant: ORACLE INTERNATIONAL CORPORATION, Redwood Shores, CA (US)

(72) Inventor: Catalin POPESCU, Atlanta, GA (US)

(21) Appl. No.: 14/596,503

(22) Filed: Jan. 14, 2015

Related U.S. Application Data
(60) Provisional application No. 62/082,677, filed on Nov. 21, 2014.

(51) Int. Cl. G06Q 30/02

(52) U.S. Cl. CPC G06Q 30/0202

(57) ABSTRACT

Systems, methods, and other embodiments that are associated with a computer application configured to execute on a computing device, for providing forecasting and management of returned retail items, are described. In one embodiment, historical retail data associated with a retail item sold at a retail location is read from a data structure associated with the computer application. The historical retail data includes sales data and returns data for the retail item over a plurality of retail periods. Based on the historical retail data, a probability is determined and generated for which a percentage of the retail item sold in one retail period will be returned in at least one subsequent retail period.

### CROSS REFERENCE TO RELATED APPLICATIONS

This disclosure claims the benefit of U.S. Provisional Patent Application serial number “62/082,677” filed Nov. 21, 2014, titled “System and Method for Forecasting and Managing Returned Merchandise in Retail”, inventors: Popescu, and assigned to the present assignee.

### BACKGROUND

Forecasting demand (e.g., sales and related inventory) is a big part of managing a retail business. Each week a certain amount of previously sold items may be returned to a retailer (e.g., at a store or an on-line retailer). Returned items can have a significant impact on forecasting demand for retail items, especially for on-line retailers. For some on-line retailers, the percentage of returned merchandise can easily be thirty percent or more. For some fashion retailers, the percentage can be even higher (e.g., fifty percent or more).

If returned merchandise is not taken into account, serious disruptions in the supply chain can occur, leading to low service levels due to lost sales, eroding margins, and increased inventory costs. For example, if returns are not properly accounted for, a retailer may end up with too much demand which needs to be marked down to be sold, leading to lower margins. Overstocking of items that are not selling increases inventory and uses up space for other merchandise. Space is often at a premium in urban or densely populated locations.

A retailer may choose to simply resell the returned merchandise. However, this can have negative implications on the replenishment system and accuracy of the forecast, which generally leads to poor service and increased inventory cost. Alternatively, a retailer may pick a fixed percentage and a fixed lag. The percentage represents the fraction of the demand that is returned, and the lag represents the number of periods after which the merchandise is returned. However, such a fixed approach is often inaccurate and leads to similar problems.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be designed as multiple elements or that multiple elements may be designed as one element. In some embodiments, an element shown as an internal component of another element may be implemented as an external component and vice versa. Furthermore, elements may not be drawn to scale.

FIG. 1 illustrates one embodiment of a computer system, having a computing device configured with a returns management and forecasting tool;

FIG. 2 illustrates one embodiment of a method, performed by the returns management and forecasting tool of the computer system of FIG. 1, for forecasting returns;

FIG. 3 illustrates one example embodiment of a table of historical retail data for a retail item;

FIG. 4 illustrates one example embodiment of a table of data generated by the returns management and forecasting tool of FIG. 1 operating on the historical retail data of FIG. 3 by executing the method of FIG. 2; and

FIG. 5 illustrates one example embodiment of a computing device upon which a returns management and forecasting tool of a computing system may be implemented.

### DETAILED DESCRIPTION

The following terms are used herein with respect to various embodiments.

The term “retail item”, as used herein, refers to merchandise sold, purchased, and/or returned in a retail environment.

The term “retail calendar”, as used herein, refers to a calendar that is used by retailers which is organized into accounting periods (e.g., quarters) for a retail year which can be made to correspond to the same periods for subsequent years, providing an invaluable forecast tool for management. For example, a retail calendar year may have 52 retail periods where each retail period corresponds to a 7-day week. A retail calendar may be in electronic form as part of a retail calendar computer application, for example.

The term “retail period”, as used herein, refers to a unit increment of time (e.g., a 7-day week) which retailers use to correlate seasonal retail periods from one year to the next in a retail calendar for the purposes of planning and forecasting. The terms “retail period” and “calendar period” may be used interchangeably herein.

The term “retail location”, as used herein, may refer to a physical store where a retail item is sold, or to an on-line store via which a retail item is sold.

The term “returns”, as used herein, refers to retail items that have been returned to a retail location subsequent to having been sold or purchased at the retail location.

The term “historical retail data”, as used herein, refers to sales and returns data, that have been recorded for a retail item, associated with past retail periods.

The term “retail period delay” or “retail period lag”, as used herein, refers to the number of retail periods from when a retail item was sold at a retail location (purchased at a retail location) to when the retail item was returned to the retail location.

Systems, methods, and other embodiments for providing forecasting and management of returned merchandise in retail associated with a computer application are disclosed. Example embodiments are discussed herein with respect to computerized retail demand forecasting and management, where return rates and lag periods are determined and updated dynamically, for example, for each item and store. In one embodiment, a returns management and forecasting (RMF) tool is disclosed that is configured to determine a probability at which a certain percentage of items sold in one retail period will be returned in the next several retail periods. Managing returned merchandise to mitigate the negative impact of returns on demand forecasting is the challenge being addressed.

A fraction of demand that is returned to a retailer may be represented as a percentage. The number of retail periods after which merchandise is returned to a retailer is referred to herein as a lag or delay. Fashion items, for example, have a relatively high percentage of returns, whereas home goods tend to not be returned very often. The lag for an urban store, where customers are able to shop and return items every day, is likely to be different from that of a countryside store, where the majority of customers shop once a week.

In one embodiment, return rates and lag periods are able to be set at a granular level for each item and store combination. Percentage and lag may be automatically estimated based on historical data, at the level where the demand is consumed by a replenishment system for each item and store combination.

Usually, point-of-sales (POS) systems used in the retail industry are capable not only of registering the details of a sales transaction, but also that of returned merchandise. For a retail item (e.g., a 12 oz. hammer), a retailer knows how many hammers were sold in a day, and also the number of hammers that were returned. What the retailer normally doesn't know is when the returned merchandise was sold. If the retailer had that piece of information, the retailer could estimate the percentage of merchandise that is returned, as well as when to expect an item to be returned.

In the following, a methodology to estimate two parameters is presented: percentage of items that are returned to the store, and the elapsed time from time of purchase to time of return. In one embodiment, a returns management and forecasting (RMF) tool is configured to perform the methodology.

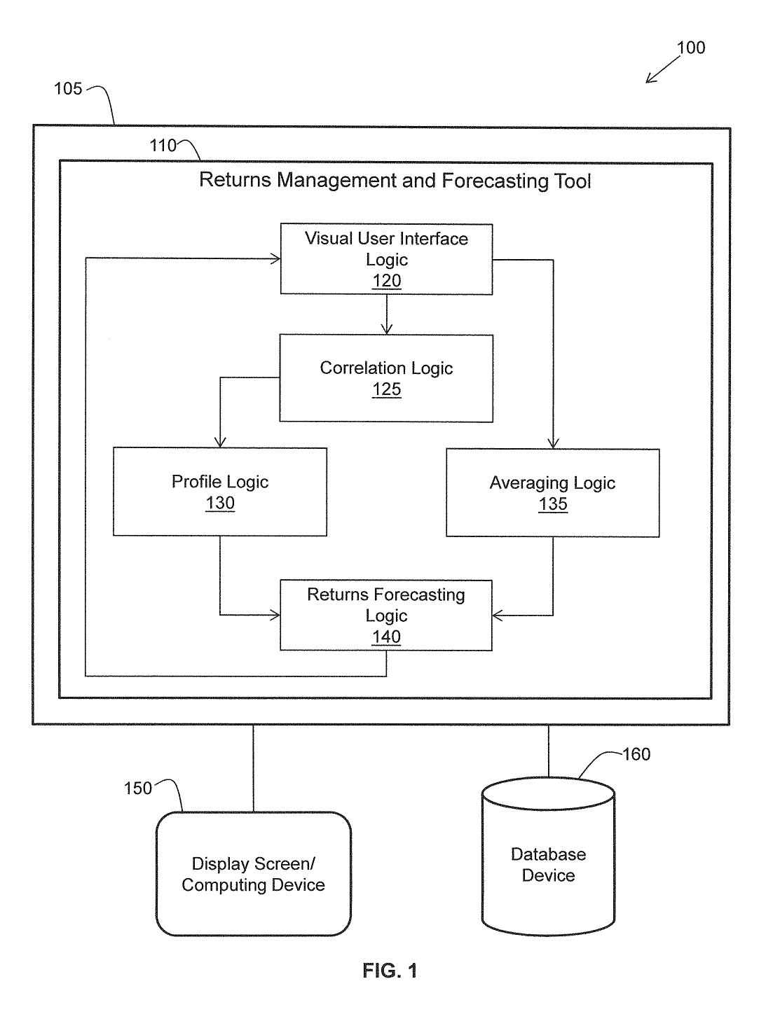

FIG. 1 illustrates one embodiment of a computer system 100, having a computing device 105 configured with a returns management and forecasting (RMF) tool 110. For example, in one embodiment, the RMF tool 110 may be part of a retail calendar computer application of a retail company, configured to forecast and manage sales and returns for retail items and various retail locations. In accordance with one embodiment, a graphical user interface is generated by the retail calendar computer application (e.g., by a visual user interface logic of the RMF tool 110).

In one embodiment, the retail calendar computer application may comprise forecasting and management software that computerizes the process for predicting returns for retail items. In one embodiment, the software and computing device 105 may be configured to operate with or be implemented as a cloud-based networking system, a software-as-a-service (SaaS) architecture, or other type of computing solution.

With reference to FIG. 1, in one embodiment, the RMF tool 110 is implemented on the computing device 105 and includes logics for implementing various functional aspects of the RMF tool 110. In one embodiment, the RMF tool 110 includes visual user interface logic 120, correlation logic 125, profile logic 130, averaging logic 135, and returns forecasting logic 140. The various logics illustrated in FIG. 1 are operably connected to each other within the RMF tool 110.

However, other embodiments may provide different logics or combinations of logics that provide the same or similar functionality as the RMF tool 110 of FIG. 1. In one embodiment, the RMF tool 110 is an executable application including algorithms and/or program modules configured to perform the functions of the logics. The application is stored in a non-transitory computer storage medium.

The computer system 100 also includes a display screen 150 operably connected to the computing device 105. In accordance with one embodiment, the display screen 150 is implemented to display views of and facilitate user interaction with a graphical user interface (GUI) generated by the visual user interface logic 120 for viewing and updating information associated with retail calendars and retail returns. The graphical user interface may be associated with a retail calendar computer application and the visual user interface logic 120 may be configured to generate the graphical user interface. In one embodiment, the RMF tool 110 is a centralized server-side application that is accessed by many users. Thus the display screen 150 may represent multiple computing devices/terminals that allow users to access and receive services from the RMF tool 110 via networked computer communications.

In one embodiment, the computer system 100 further includes at least one database device 160 operably connected to the computing device 105 or a network interface to access the database device 160 via a network connection. In accordance with one embodiment, the database device 160 is configured to store and manage data structures (e.g., records of historical retail data and forecasted returns data) associated with the RMF tool 110 in a database system (e.g., a retail calendar computer application).

Referring back to the logics of the RMF tool 110 of FIG. 1, in one embodiment, the visual user interface logic 120 is configured to generate a graphical user interface to facilitate user interaction with the RMF tool 110. For example, the visual user interface logic 120 includes program code that generates and causes the graphical user interface to be displayed based on an implemented graphical design of the interface. In response to user actions and selections via the GUI, associated aspects of demand and returns for retail items may be manipulated.

For example, the visual user interface logic 120 is configured to facilitate receiving inputs and reading historical retail data, associated with a retail item sold at a retail location, from at least one data structure associated with (and accessible by) a retail calendar computer application (e.g., a retail returns management and forecasting application) via the graphical user interface. Historical retail data may include, for example, sales data for a particular item sold at a particular location and associated returns data. The data may be accessed via network communications. The historical retail data may be segmented into retail periods of past weeks, with each past week having numerical values assigned to it to indicate the number of items sold and returned for that week, in accordance with one embodiment.

Furthermore, the visual user interface logic 120 is configured to facilitate the outputting and displaying of predicted returns data, via the graphical user interface, on the display screen 150, where the displayed predicted returns data indicates a probability for which a percentage of a retail item sold in one retail period will be returned in at least one subsequent retail period. In one embodiment, returns forecasting logic 140 is configured to operably interact with the visual user interface logic 120 to facilitate displaying of predicted returns data of an output data structure.

Predicted returns data may include, for example, one month of predicted or forecasted returns data for the particular retail item at the particular retail location. The predicted returns data may be segmented into retail periods of future weeks, with each future week having a numerical value assigned to it to indicate the number of items (e.g., 12) predicted to be returned for that week, in accordance with one embodiment. For example, a percentage (e.g., 12%) of a retail item predicted to be returned with a particular probability (e.g., 0.75) in a particular future retail period may be correlated to a total number (e.g., 100) of the retail item sold in an earlier retail period. The number of retail periods between the future retail period and the earlier retail period is the lag or delay between sales and returns.

In one embodiment, the correlation logic 125 is configured to determine a cross-correlation between the sales data and the returns data of the historical retail data for multiple retail period delays between the sales data and the returns data. That is, the correlation logic 125 generates cross-correlation data by performing a cross-correlation operation between the sales data and the returns data for multiple retail period delays between the sales data and the returns data. The cross-correlation data provides an indication of the amount of similarity between when an item is sold and when it is returned. For example, the cross-correlation data may indicate that an item sold in one retail period, if eventually returned, will most-likely be returned two retail periods later.

In one embodiment, the profile logic 130 is configured to receive the cross-correlation data from the correlation logic 125 and generate a return profile, based on the cross-correlation data, over retail period delays of the multiple retail period delays that are positively cross-correlated (i.e., that have a positive cross-correlation value). The return profile represents a likelihood that a returned retail item was purchased in a particular previous retail period.

In one embodiment, the averaging logic 135 is configured to generate average return percentage data, based on the historical retail data, over retail period delays of the multiple retail period delays that are positively cross-correlated. The returns forecasting logic 140 is configured to generate and display a final percentage return value based on the return profile and the average return percentage data. The final percentage return value represents a percentage of the retail item sold that is forecast to be returned over at least one next retail period with probability given by the return profile.

In accordance with one embodiment, the returns forecasting logic 140 of the returns management and forecasting tool 110 is configured to transform an output data structure. The output data structure may be associated with (and accessible by) a retail calendar computer application and may be transformed by populating the output data structure with, for example, the return profile and the final percentage return value. In one embodiment, returns forecasting logic 140 is configured to operably interact with the visual user interface logic 120 to facilitate displaying of the return profile and the final percentage return value of the output data structure, via the graphical user interface, on the display screen 150.

In accordance with one embodiment, the returns forecasting logic 140 is configured to determine an order quantity for a retail item based on, at least in part, at least one of the final percentage return value and the return profile. For example, if the final percentage return value and the return profile indicate that 10% of a retail item purchased two weeks ago is likely to be returned with 80% probability two weeks from now, the returns forecasting logic 140 may adjust an order quantity for the retail item downward to account for the expected returns.

In accordance with one embodiment, the returns forecasting logic 140 is configured to predict an inventory of the retail item for a future retail period based on, at least in part, at least one of the final percentage return value and the return profile. For example, after adjusting the order quantity for the retail item downward based on the final percentage return value and the return profile as discussed above herein, the returns forecasting logic 140 may adjust a predicted inventory level for a retail period occurring two weeks from now based on the adjusted order quantity.

In this manner, a returns management and forecasting tool 110 (e.g., implemented as part of a retail calendar computer application) can accurately predict a percentage of sold retail items that are likely to be returned, and when they will likely be returned. As a result, a retailer may use the prediction to more accurately determine an order quantity for future retail periods. Similarly, large numbers of individual items to be sold at large numbers of individual retail locations may be treated individually by the same tool 110.

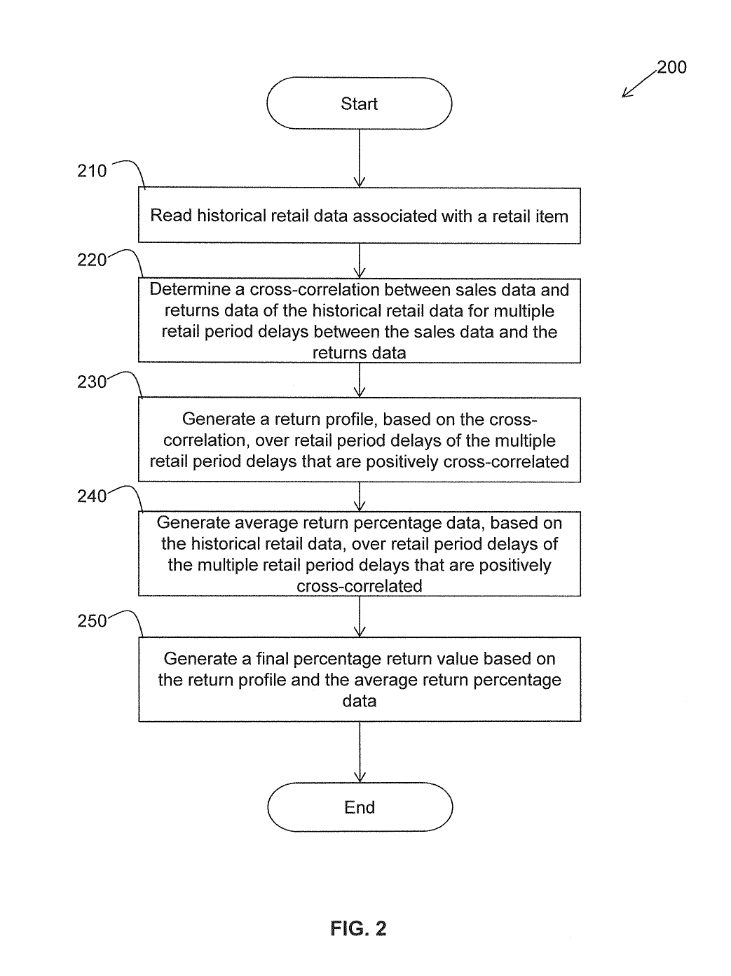

FIG. 2 illustrates one embodiment of a method 200, performed by the returns management and forecasting tool 110 of the computer system 100 of FIG. 1, for forecasting returns. Method 200 summarizes the operation of correlation logic 125, profile logic 130, averaging logic 135, and returns forecasting logic 140. Method 200 is implemented to be performed by the RMF tool 110 of FIG. 1, or by a computing device configured with an algorithm of the method 200. Method 200 will be described from the perspective that a retail calendar has many retail periods (e.g., weeks) that are organized in a particular manner (e.g., four (4) thirteen (13) week quarters) over a typical calendar year. A retail period may occur in the past or in the future. An item sold in one retail period may be returned in a subsequent retail period resulting in a delay (in retail periods) between when the item is sold and when the item is returned.

Upon initiating method 200, at block 210, historical retail data associated with a retail item sold at a retail location is read from at least one data structure associated with, for example, a retail calendar computer application. In accordance with one embodiment, the historical retail data is read by the returns management and forecasting tool 110, implemented on the computing device 105, from the database device 160. The historical retail data includes sales data and returns data for the retail item over a plurality of past retail periods.

At block 220, a cross-correlation operation is performed between the sales data and the returns data of the historical retail data for multiple retail period delays between the sales data and the returns data. The resulting cross-correlation data provides an indication of the amount of similarity between when the retail item is sold and when it is returned. For example, the cross-correlation data may indicate that a retail item sold in one retail period, if eventually returned, will most-likely be returned three retail periods later. In accordance with one embodiment, the historical retail data is transformed into the cross-correlation data by the correlation logic 125 of the returns management and forecasting tool 110.

At block 230, a return profile is generated, based on the cross-correlation data, over retail period delays of the multiple retail period delays that are positively cross-correlated. The return profile represents a likelihood that a returned retail item was purchased in a particular previous retail period. In accordance with one embodiment, the cross-correlation data is transformed into the return profile by the profile logic 130 of the returns management and forecasting tool 110.

At block 240, average return percentage data is generated, based on the historical retail data, over retail period delays of the multiple retail period delays that are positively cross-correlated. In accordance with one embodiment, the historical retail data is transformed into the average return percentage data by the averaging logic 135 of the returns management and forecasting tool 110.

At block 250, a final percentage return value is generated based on the return profile and the average return percentage data, and the value may be displayed on a display device. The final percentage return value represents the percentage of the retail item sold that is predicted to be returned over at least one subsequent retail period with probability given by the return profile. In accordance with one embodiment, the return profile and the average return percentage data are transformed into the final percentage return value by the returns forecasting logic 140 of the returns management and forecasting tool 110.

In this manner, retail returns may be predicted, taking into account the lag or delay between the sale of an item and the return of the item in a probabilistic fashion. The predicted retail return information may be used to adjust order quantities for the retail item and predict future inventory levels of the retail item. In accordance with one embodiment, an order quantity may be transformed based on at least one of the final percentage return value and the return profile.

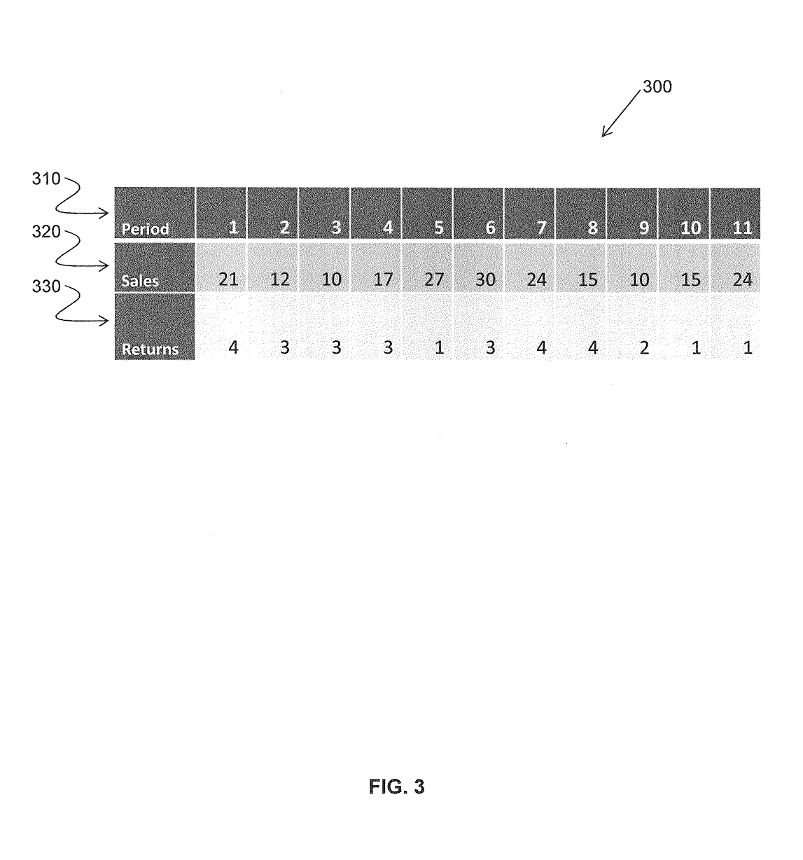

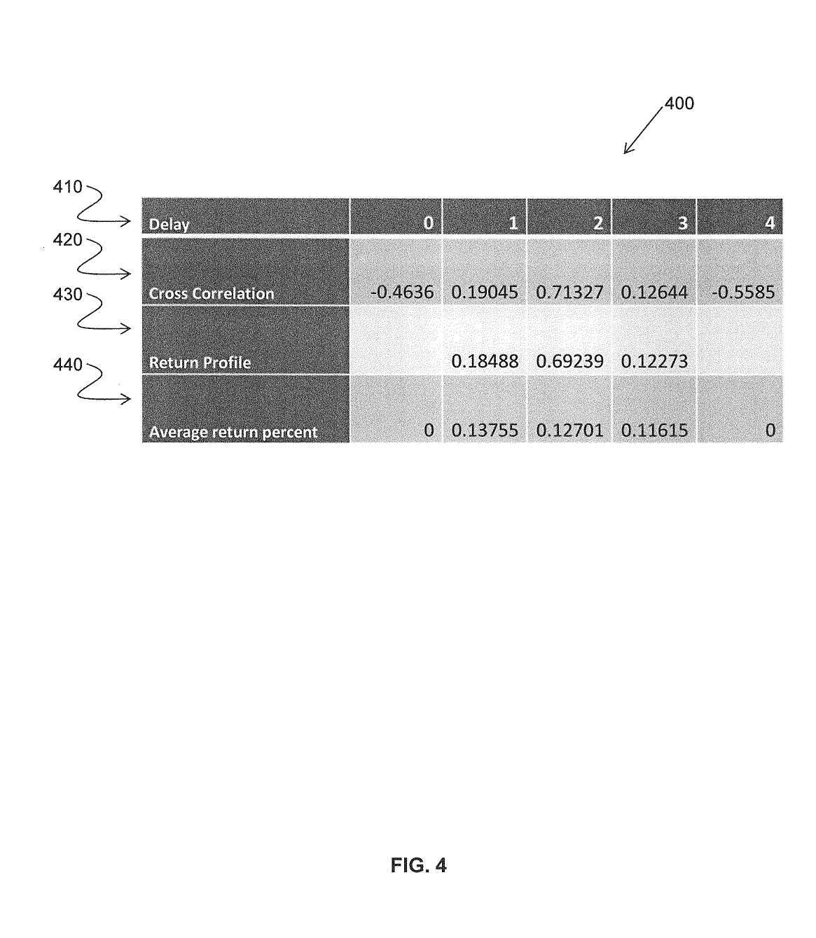

Method 200 may be repeated for a plurality of retail items sold at a plurality of retail locations. In this manner, retail returns may be predicted for multiple retail items across multiple retail locations in a probabilistic fashion. A detailed example of method 200 is discussed below herein with respect to FIG. 3 and FIG. 4.

FIG. 3 illustrates one example embodiment of a table 300 of historical retail data for a retail item. The table 300 may be considered to represent a data structure, for example, populated with historical retail data for eleven (11) retail periods 310. The historical retail data includes sales data 320 and returns data 330. In one embodiment, table 300 may be part of a database stored on a computer storage device.

For example, referring to the table of FIG. 3, during retail period #5, twenty seven (27) units of the retail item were sold and one (1) unit of the retail item was returned. During retail period #9, ten (10) units of the retail item were sold and two (2) units of the retail item were returned. In general, it is assumed herein that a retail item returned in a particular retail period was sold/purchased in a previous retail period (e.g., one (1), two (2), or three (3) retail periods prior to the return).

FIG. 4 illustrates one example embodiment of a table 400 of data generated by the returns management and forecasting tool 110 of FIG. 1 operating on the historical retail data of FIG. 3 by executing the method 200 of FIG. 2. The table 400 may be considered to represent an output data structure. In accordance with one embodiment, the output data structure may be transformed by populating the output data structure with output data generated by the returns management and forecasting tool 110 for five (5) retail delay periods 410 (i.e., lags between the sales data 320 and the returns data 330).

Referring to the table 400 of FIG. 4, a cross-correlation operation is performed between the sales data 320 and the returns data 330 of table 300, to generate cross-correlation data 420 for 0, 1, 2, 3, and 4 retail period delays between the sales data 320 and the returns data 330. For retail period delays 0 (no delay) and 4, the cross-correlation data are negative indicating that the metrics are not similar for those delays. Therefore, in this example, it is unlikely that any of the retail item sold in a given retail period is returned in the same retail period (no delay) or four (4) retail periods later.

For retail period delays 1, 2, and 3, the cross-correlation data are 0.19045, 0.71327, and 0.12644, respectively. Positive cross-correlation data indicate that the metrics are similar for those delays. Therefore, in this example, it is likely that some of the retail item sold in a given retail period was returned 1, 2, and 3 retail periods later. Furthermore, based on the magnitude of the cross-correlation data, a retail item sold in a given retail period is most-likely to be returned two (2) retail periods later (i.e., with a delay of 2).

Referring again to table 400 of FIG. 4, the positive cross-correlation data are processed to create the return profile 430. The return profile 430 has positive values for retail period delays 1, 2, and 3 and is calculated as:

Return Profile (delay=i)=cross correlation value (delay=i)/(sum of positive cross-correlation values).

The resulting return profile values are 0.18488, 0.69239, and 0.12273 for retail period delays 1, 2, and 3, respectively. The return profile 430 represents a probability or likelihood that a returned retail item was sold/purchased in a particular retail period. For example, referring to the return profile 430 of table 400, there is a probability of 0.69239 (or 69.239%) that a retail item returned in a current retail period was sold/purchased two (2) retail periods ago.

Referring again to table 400 of FIG. 4, the historical retail data (sales data and returns data) of table 300 of FIG. 3 are used to calculate average return percentage data 440 for all retail period delays where the cross-correlation is positive. Therefore, for delays i=1, 2, and 3, the following is performed:

Average over all retail periods t of (return (t−i)/sales(t)).

For example, for delay=2:

Average=1/9*(3/21+3/12+1/10+3/17+4/27+4/30+2/24+1/15+1/10)=0.12701.

In this manner, referring to table 400, the average return percent values for retail period delays 1, 2, and 3 are, respectively, 0.13755, 0.12701, and 0.11615. A final percentage return value may then be calculated, based on the return profile 430 and the average return percentage data 440. The final percentage return value represents the percentage of the retail item sold that is forecast to be returned over at least one subsequent retail period with probability given by the return profile.

To calculate the final percentage return value, the average return percentage data 440 for all of the retail period delays having positive cross-correlation are multiplied with the corresponding return profile values and summed as follows:

Final return percentage value (0.18488*0.13755)+(0.69239*0.12701)+(0.12273*0.11615)=0.12763 or, 12.76% of items sold in a given retail period will be returned in the next three retail periods, with the probability given by the values of the return profile.

A replenishment system can use this information to adjust order quantities and reduce inventory cost. For example, in accordance with one embodiment and based on the example above, an order quantity for a retail item may be reduced by 12.76% to account for the expected increase in inventory due to the returns. A reduction in inventory cost of as little as 1% can amount to millions of dollars in savings per year for some retailers. In this manner, a retailer can more accurately forecast and manage demand for merchandise by mitigating the negative effects that can be caused by returns.

Systems, methods, and other embodiments that are associated with a computer application configured to execute on a computing device, for providing forecasting and management of returned retail items, have been described. In one embodiment, historical retail data associated with a retail item sold at a retail location is read from a data structure associated with (and accessible by) the computer application. Sales data and returns data of the historical retail data are cross-correlated with each other for multiple retail period delays between the sales data and the returns data, and a return profile of probabilities is generated based on the cross-correlation results. Average return percentage data is generated based on the historical retail data. The return profile and the average return percentage data are transformed to generate a final percentage return value representing a percentage of the retail item sold which is forecast to be returned during at least one subsequent retail period.

Computing Device Embodiment

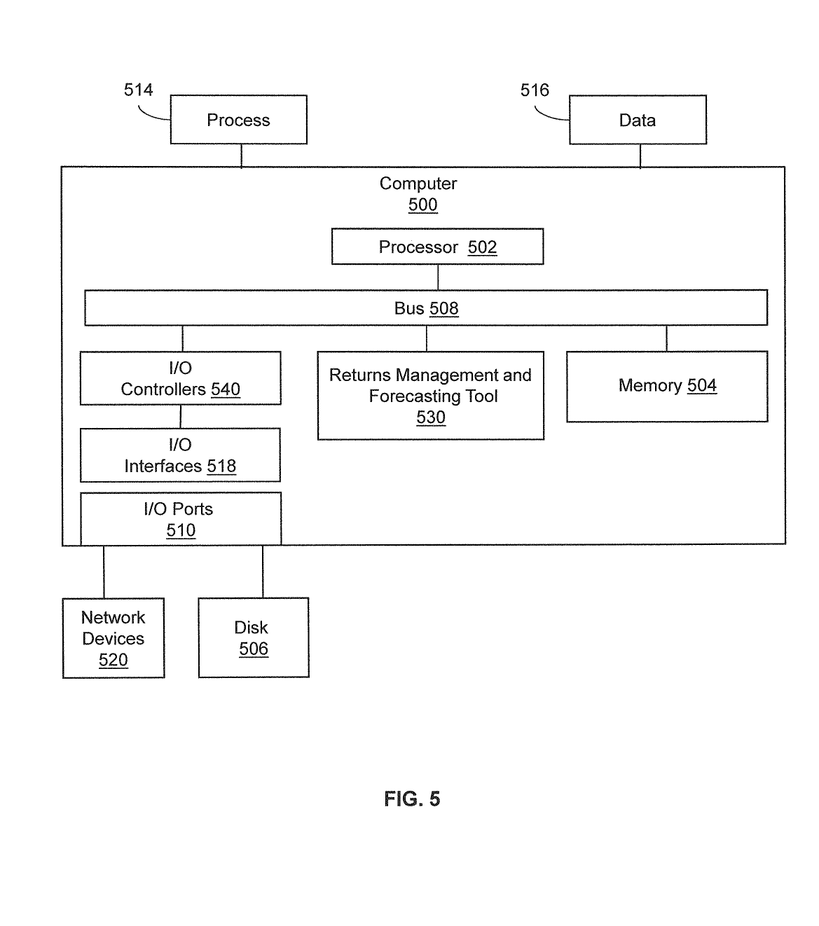

FIG. 5 illustrates an example computing device that is configured and/or programmed with one or more of the example systems and methods described herein, and/or equivalents. FIG. 5 illustrates one example embodiment of a computing device upon which an embodiment of a returns management and forecasting (RMF) tool may be implemented. The example computing device may be a computer 500 that includes a processor 502, a memory 504, and input/output ports 510 operably connected by a bus 508.

In one example, the computer 500 may include RMF tool 530 (corresponding to RMF tool 110 from FIG. 1) configured with a programmed algorithm as disclosed herein to determine and generate a probability at which a certain percentage of items sold in one period will be returned in the next several periods. The probability may be displayed as a value on a computing display device. In different examples, the tool 530 may be implemented in hardware, a non-transitory computer-readable medium with stored instructions, firmware, and/or combinations thereof. While the tool 530 is illustrated as a hardware component attached to the bus 508, it is to be appreciated that in other embodiments, the tool 530 could be implemented in the processor 502, stored in memory 504, or stored in disk 506.

In one embodiment, tool 530 or the computer 500 is a means (e.g., structure: hardware, non-transitory computer-readable medium, firmware) for performing the actions described. In some embodiments, the computing device may be a server operating in a cloud computing system, a server configured in a Software as a Service (SaaS) architecture, a smart phone, laptop, tablet computing device, and so on.

The means may be implemented, for example, as an ASIC programmed to facilitate the forecasting and managing of returned merchandise for a retailer. The means may also be implemented as stored computer executable instructions that are presented to computer 500 as data 516 that are temporarily stored in memory 504 and then executed by processor 502.

Tool 530 may also provide means (e.g., hardware, non-transitory computer-readable medium that stores executable instructions, firmware) for facilitating the forecasting and managing of returned merchandise for a retailer.

Generally describing an example configuration of the computer 500, the processor 502 may be a variety of various processors including dual microprocessor and other multi-processor architectures. A memory 504 may include volatile memory and/or non-volatile memory. Non-volatile memory may include, for example, ROM, PROM, and so on. Volatile memory may include, for example, RAM, SRAM, DRAM, and so on.

A storage disk 506 may be operably connected to the computer 500 via, for example, an input/output interface (e.g., card, device) 518 and an input/output port 510. The disk 506 may be, for example, a magnetic disk drive, a solid state disk drive, a floppy disk drive, a tape drive, a Zip drive, a flash memory card, a memory stick, and so on. Furthermore, the disk 506 may be a CD-ROM drive, a CD-R drive, a CD-RW drive, a DVD ROM, and so on. The memory 504 can store a process 514 and/or a data 516, for example. The disk 506 and/or the memory 504 can store an operating system that controls and allocates resources of the computer 500.

The computer 500 may interact with input/output devices via the i/o interfaces 518 and the input/output ports 510. Input/output devices may be, for example, a keyboard, a microphone, a pointing and selection device, cameras, video cards, displays, the disk 506, the network devices 520, and so on. The input/output ports 510 may include, for example, serial ports, parallel ports, and USB ports.

The computer 500 can operate in a network environment and thus may be connected to the network devices 520 via the i/o interfaces 518, and/or the i/o ports 510. Through the network devices 520, the computer 500 may interact with a network. Through the network, the computer 500 may be logically connected to remote computers. Networks with which the computer 500 may interact include, but are not limited to, a LAN, a WAN, and other networks.

### Definitions and Other Embodiments

In another embodiment, the described methods and/or their equivalents may be implemented with computer executable instructions. Thus, in one embodiment, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (SaaS) architecture, a smart phone, and so on). In one embodiment, a computing device is implemented with one or more executable algorithms that are configured to perform any of the disclosed methods.

In one or more embodiments, the disclosed methods or their equivalents are performed by either: computer hardware configured to perform the method; or computer software embodied in a non-transitory computer-readable medium including an executable algorithm configured to perform the method.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, less than all the illustrated blocks may be used to implement an example methodology. Blocks may be combined or separated into multiple actions/components. Furthermore, additional and/or alternative methodologies can employ additional actions that are not illustrated in blocks. The methods described herein are limited to statutory subject matter under 35 U.S.C §101.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

ASIC: application specific integrated circuit.

CD: compact disk.

CD-R: CD recordable.

CD-RW: CD rewriteable.

DVD: digital versatile disk and/or digital video disk.

HTTP: hypertext transfer protocol.

LAN: local area network.

RAM: random access memory.

DRAM: dynamic RAM.

SRAM: synchronous RAM.

ROM: read only memory.

PROM: programmable ROM.

EPROM: erasable PROM.

EEPROM: electrically erasable PROM.

USB: universal serial bus.

WAN: wide area network.

An “operable connection”, or a connection by which entities are “operably connected”, is one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, non-transitory computer-readable medium). Logical and/or physical communication channels can be used to create an operable connection.

A “data structure”, as used herein, is an organization of data in a computing system that is stored in a memory, a storage device, or other computerized system. A data structure may be any one of, for example, a data field, a data file, a data array, a data record, a database, a data table, a graph, a tree, a linked list, and so on. A data structure may be formed from and contain many other data structures (e.g., a database includes many data records). Other examples of data structures are possible as well, in accordance with other embodiments.

“Computer communication”, as used herein, refers to a communication between computing devices (e.g., computer, personal digital assistant, cellular telephone) and can be, for example, a network transfer, a file transfer, an applet transfer, an email, an HTTP transfer, and so on. A computer communication can occur across, for example, a wireless system (e.g., IEEE 802.11), an Ethernet system (e.g., IEEE 802.3), a token ring system (e.g., IEEE 802.5), a LAN, a WAN, a point-to-point system, a circuit switching system, a packet switching system, and so on.

“Computer-readable medium” or “computer storage medium”, as used herein, refers to a non-transitory medium that stores instructions and/or data configured to perform one or more of the disclosed functions when executed. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, solid state storage device (SSD), flash drive, and other media from which a computer, a processor or other electronic device can function with. Each type of media, if selected for implementation in one embodiment, may include stored instructions of an algorithm configured to perform one or more of the disclosed and/or claimed functions. Computer-readable media described herein are limited to statutory subject matter under 35 U.S.C §101.

“Logic”, as used herein, represents a component that is implemented with computer or electrical hardware, firmware, a non-transitory medium with stored instructions of an executable application or program module, and/or combinations of these to perform any of the functions or actions as disclosed herein, and/or to cause a function or action from another logic, method, and/or system to be performed as disclosed herein. Logic may include a microprocessor programmed with an algorithm, a discrete logic (e.g., ASIC), at least one circuit, an analog circuit, a digital circuit, a programmed logic device, a memory device containing instructions of an algorithm, and so on, any of which may be configured to perform one or more of the disclosed functions. In one embodiment, logic may include one or more gates, combinations of gates, or other circuit components configured to perform one or more of the disclosed functions. Where multiple logics are described, it may be possible to incorporate the multiple logics into one logic. Similarly, where a single logic is described, it may be possible to distribute that single logic between multiple logics. In one embodiment, one or more of these logics are corresponding structure associated with performing the disclosed and/or claimed functions. Choice of which type of logic to implement may be based on desired system conditions or specifications. Logic is limited to statutory subject matter under 35 U.S.C. §101.

“User”, as used herein, includes but is not limited to one or more persons, computers or other devices, or combinations of these.

“Operable interaction”, as used herein, refers to the logical or communicative cooperation between two or more logics via an operable connection to accomplish a function.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described. Thus, this disclosure is intended to embrace alterations, modifications, and variations that fall within the scope of the appended claims, which satisfy the statutory subject matter requirements of 35 U.S.C. §101.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use.

To the extent that the phrase “one or more of, A, B, and C” is used herein, (e.g., a data store configured to store one or more of, A, B, and C) it is intended to convey the set of possibilities A, B, C, AB, AC, BC, and/or ABC (e.g., the data store may store only A, only B, only C, A&B, A&C, B&C, and/or A&B&C). It is not intended to require one of A, one of B, and one of C. When the applicants intend to indicate “at least one of A, at least one of B, and at least one of C”, then the phrasing “at least one of A, at least one of B, and at least one of C” will be used.

What is claimed is:

1. A method implemented by a computer application configured to execute on a computing device, wherein the computer application is configured to process retail data in electronic form, the method comprising:
for a retail item sold at a retail location:
reading, from at least one data structure, historical retail data representing sales data and returns data for the retail item over a plurality of retail periods; and
determining and generating, based on the historical retail data, a probability for which a percentage of the retail item sold in one retail period will be returned in at least one subsequent retail period.

2. The method of claim 1, wherein the determining comprises:
generating cross-correlation data by performing a cross-correlation operation between the sales data and the returns data for multiple retail period delays between the sales data and the returns data;
generating a return profile, based on the cross-correlation data, over retail period delays of the multiple retail period delays that are positively cross-correlated, where the return profile represents a likelihood that a returned retail item was purchased in a particular previous retail period;
generating average return percentage data, based on the historical retail data, over retail period delays of the multiple retail period delays that are positively cross-correlated; and
generating a final percentage return value, based on the return profile and the average return percentage data, representing the percentage of the retail item sold that is forecast to be returned over the at least one subsequent retail period with probability given by the return profile.

3. The method of claim 2, further comprising repeating the method for a plurality of retail items sold at a plurality of retail locations.

4. The method of claim 2, further comprising determining an order quantity for the retail item based, at least in part, on at least one of the final percentage return value and the return profile.

5. The method of claim 1, wherein the sales data includes a numerical amount of the retail item sold for each retail period of the plurality of retail periods.

6. The method of claim 1, wherein the returns data includes a numerical amount of the retail item returned for each retail period of the plurality of retail periods.

7. The method of claim 1, wherein each retail period of the plurality of retail periods represents one of a day, a week, a month, or a year.

8. The method of claim 1, wherein each retail period delay of the multiple retail period delays represents one of a day, a week, a month, or a year.

9. The method of claim 1, wherein the retail location includes one of a physical store or an on-line store.

10. A computing system, comprising:
visual user interface logic configured to facilitate inputting of historical retail data, representing sales data and returns data for a retail item over a plurality of retail periods, into at least one data structure associated with a retail returns management and forecasting application;
correlation logic configured to determine a cross-correlation between the sales data and the returns data for multiple retail period delays between the sales data and the returns data;
profile logic configured to generate a return profile, based on the cross-correlation, over retail period delays of the multiple retail period delays that are positively cross-correlated, where the return profile represents a likelihood that a returned retail item was purchased in a particular previous retail period;
averaging logic configured to generate average return percentage data, based on the historical retail data, over retail period delays of the multiple retail period delays that are positively cross-correlated; and
returns forecasting logic configured to generate a final percentage return value, based on the return profile and the average return percentage data, representing a percentage of the retail item sold that is forecast to be returned during at least one next retail period with probability given by the return profile.

11. The computing system of claim 10, wherein the returns forecasting logic is configured to determine an order quantity for the retail item based, at least in part, on at least one of the final percentage return value and the return profile.

12. The computing system of claim 10, wherein the returns forecasting logic is configured to predict an inventory of the retail item for a future retail period based, at least in part, on at least one of the final percentage return value and the return profile.

13. The computing system of claim 10, further comprising a display screen configured to display and facilitate user interaction with at least a graphical user interface associated with the retail returns management and forecasting application, wherein the visual user interface logic is configured to generate the graphical user interface.

14. The computing system of claim 13, wherein the returns forecasting logic is configured to transform an output data structure, associated with the retail returns management and forecasting application, by populating the output data structure with at least the return profile and the final percentage return value.

15. The computing system of claim 14, wherein the returns forecasting logic is configured to operably interact with the visual user interface logic to facilitate displaying of at least the return profile and the final percentage return value of the output data structure, via the graphical user interface, on the display screen.

16. The computing system of claim 10, further comprising a database device configured to store data structures associated with the retail returns management and forecasting application.

17. A non-transitory computer-readable medium storing computer-executable instructions that are part of an algorithm that, when executed by a computer, cause the computer to perform a method, wherein the instructions comprise instructions configured for:
reading historical retail data, representing sales data and returns data associated with a retail item sold at a retail location over a plurality of retail periods, from at least one data structure associated with a retail returns management and forecasting application;
transforming the historical retail data into cross-correlation data, representing a similarity between the sales data and the returns data over multiple retail period delays between the sales data and the returns data;
transforming the cross-correlation data into a return profile over retail period delays of the multiple retail period delays that are positively cross-correlated, where the return profile represents a likelihood that a returned retail item was purchased in a particular previous retail period;
transforming the historical retail data into average return percentage data over retail period delays of the multiple retail period delays that are positively cross-correlated; and
transforming the return profile and the average return percentage data into a final percentage return value representing a percentage of the retail item sold that is forecast to be returned during at least one next retail period with probability given by the return profile.

18. The non-transitory computer-readable medium of claim 17, wherein the instructions further include instructions configured for transforming at least one output data structure, associated with the retail returns management and forecasting application, by populating the at least one output data structure with at least the return profile and the final percentage return value.

19. The non-transitory computer-readable medium of claim 17, wherein the instructions further include instructions configured for transforming an order quantity for the retail item based, at least in part, on at least one of the final percentage return value and the return profile.

20. The non-transitory computer-readable medium of claim 17, wherein the instructions further include instructions configured for repeating the method for a plurality of retail items sold at a plurality of retail locations.
